(19) United States
(12) Patent Application Publication
(10) Pub. No.: US 2018/0272861 A1
(43) Pub. Date: Sep. 27, 2018

(54) FUEL TANK SYSTEM

(71) Applicant: DENSO CORPORATION, Kariya-city (JP)

(72) Inventor: Yuichiro MIURA, Kariya-city (JP)

(21) Appl. No.: 15/910,154

(22) Filed: Mar. 2, 2018

(30) Foreign Application Priority Data
Mar. 22, 2017 (JP) 2017-55629

(51) Int. Cl. B60K 15/035; B67D 7/04

(52) U.S. Cl. CPC B60K 15/03519; B60K 2015/0319; B67D 7/048; B67D 7/0492

(57) ABSTRACT

A tank passage is connected at its one end to a fuel tank, which stores fuel. A canister is connected to the other end of the tank passage and adsorbs evaporated fuel generated by evaporation of fuel in the fuel tank. An electric control valve is operable with current supply to control an amount of fluid flowing through the tank passage by varying an open rate of the tank passage. A fill-up detection part detects that the fuel tank is filled up with fuel based on a fuel level in the fuel tank. A control part controls an operation of the electric control valve. The control part controls the electric control valve in the valve closing direction, which decreases the open rate, when the fill-up detection part detects that the fuel tank is filled up with fuel.

### CROSS REFERENCE TO RELATED APPLICATION

The present application is based on Japanese patent application No. 2017-55629 filed on Mar. 22, 2017, the whole contents of which are incorporated herein by reference.

### FIELD

The present disclosure relates to a fuel tank system.

### BACKGROUND

In one type of conventional fuel tank systems, a control valve is provided to open and close a tank passage, which connects a fuel tank and a canister. For example, in a fuel tank system disclosed in JP 2001-206081A, a float valve and a pressure sensor are provided. The float valve is driven by buoyant force and closes a tank passage when fuel is filled up in a fuel tank. The pressure sensor detects an inner pressure of the fuel tank. In this fuel tank system, the inner pressure of the fuel tank increases rapidly in refilling the fuel tank, when the fuel is filled up in the fuel tank and float valve closes the tank passage. When the pressure sensor detects the rapid pressure change, the control valve is controlled to close the tank passage.

According to the fuel tank system described above, the float valve closes the tank passage to raise the inner pressure of the fuel tank and the pressure sensor detects the rise of the tank inner pressure to control the control valve to close. This fuel tank system needs both of the float valve and the pressure sensor, thus complicating whole system configuration.

In case that the float valve is eliminated in the fuel tank system disclosed above, the inner pressure of the fuel tank rises only slightly in the course of refilling of fuel into the fuel tank. As a result, the pressure sensor may not be able to detect the rise of the inner pressure of the fuel tank. When the pressure sensor fails to detect the rise of the inner pressure of the fuel tank, fuel is likely to be supplied to the fuel tank continuously even after the fuel tank is filled up. As a result, the fuel is likely to flow to the canister side through the tank passage. The fuel is likely to overflow from a filler neck of the fuel tank.

### SUMMARY

It is therefore an object to provide a fuel tank system, which appropriately controls a flow amount of fluid flowing through a tank passage at time of fill-up of a fuel tank, in simple configuration.

According to one aspect, a fuel tank system comprises a tank passage, a canister, an electric control valve, a fill-up detection part and a control part. The tank passage has one end connected to a fuel tank, which stores fuel. The canister is connected to an other end of the tank passage for adsorbing evaporated fuel generated by evaporation of the fuel in the fuel tank. The electric control valve is operable with current supply and controls an amount of fluid flowing through the tank passage by varying an open rate of the tank passage. The fill-up detection part detects that the fuel tank is filled up with fuel based on a fuel level in the fuel tank without detecting an inner pressure of the fuel tank. The control part controls an operation of the electric control valve. The control part controls the electric control valve in a valve closing direction to decrease the open rate of the tank passage, when the fill-up detection part detects that the fuel tank is filled up with fuel.

### BRIEF DESCRIPTION OF THE DRAWINGS

FIG. 1 is a schematic view showing a fuel tank system according to a first embodiment;

FIG. 2 is a schematic view showing a fuel tank system according to a second embodiment;

FIG. 3 is a schematic view showing a fuel tank system according to a third embodiment;

FIG. 4 is a schematic view showing a fuel tank system according to a fourth embodiment;

FIG. 5 is a time chart showing an exemplary operation of the fuel tank system according to the fourth embodiment;

FIG. 6 is a time chart showing an exemplary operation of a fuel tank system according to a fifth embodiment;

FIG. 7 is a schematic view showing one state of an electric control valve of a fuel tank system according to a sixth embodiment; and

FIG. 8 is a schematic view showing the other state of the electric control valve of the fuel tank system according to the sixth embodiment.

### DETAILED DESCRIPTION OF THE EMBODIMENT

A fuel tank system will be described below with reference to multiple embodiments. Substantially same structural parts are designated with same reference numerals among the multiple embodiments for brevity.

### First Embodiment

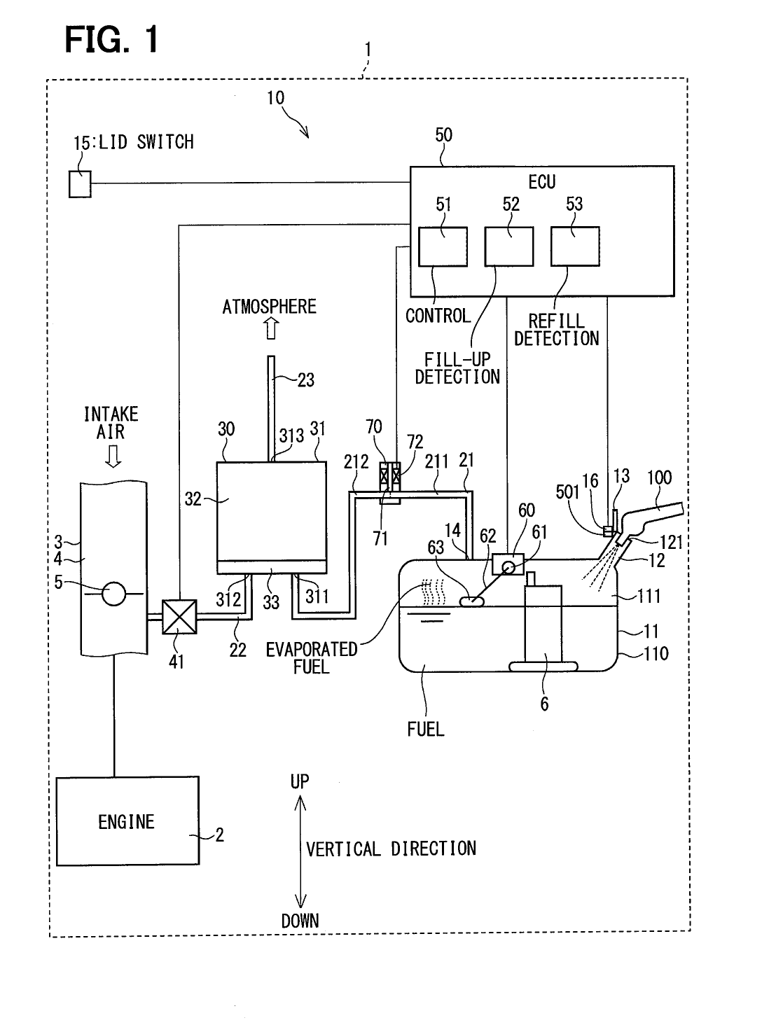

A fuel tank system according to a first embodiment is shown in FIG. 1. A fuel tank system 10 according to the first embodiment is provided in a vehicle 1 provided with an engine 2, which is a gasoline internal combustion engine. The vehicle 1 includes, in addition to the engine 2 and the fuel tank system 10, an intake pipe 2 and a fuel tank 11. The engine 2 generates a driving power for driving the vehicle 1. The engine 2 is supplied with gasoline as fuel to drive the vehicle 1.

The intake pipe 3 is connected to the engine 2. An intake passage 4 is formed inside the intake pipe 3. One end of the intake passage 4 is connected to a combustion chamber of the engine 2 and the other end of the intake passage 4 is open to atmosphere. The intake passage 4 leads air in the atmosphere into the combustion chamber of the engine 2. The air (also referred to as intake air) taken into the combustion chamber through the intake passage 4 is mixed with fuel, which is injected from a fuel injection valve (not shown) for example, to provide mixture of air and fuel. The engine 2 operates by combustion of the mixture in the combustion chamber. A throttle valve 5 is provided in the intake passage 4. The throttle valve 5 regulates an amount of air taken into the engine 2 by changing an air flow area in the intake passage 4, that is, an open rate of the intake passage 4, by regulating an open angle of the throttle valve 5.

The fuel tank 11 stores fuel, which is to be supplied to the engine 2. A fuel pump 6 is provided inside the fuel tank 11. The fuel pump 6 takes in the fuel in the fuel tank 11 and discharges the fuel after pressurization. The fuel discharged from the fuel pump 6 is supplied to the engine 2 through a fuel pipe, a fuel rail and the fuel injection valve, which are not shown. The fuel tank 11 is formed of a tank body 110, a filler neck (fuel supply inlet) 12 and the like. The tank body 110 is made of a metal or resin and formed in a box shape, for example. The tank body 110 has a tank inner space 111 in its inside to store fuel therein.

The filler neck 12 is connected to the tank body 110. One end of the filler neck 12 is connected to the tank body 110. The other end of the filler neck 12 is provided with a filler neck opening 121. The filler neck 12 communicates the tank inner space 111 and an outside of the tank body 110. The filler neck 12 is formed to be located at a vertically elevated position relative to the tank body 110, that is, at an upper side of the tank body 110, under a state that the fuel tank 11 is mounted in the vehicle 1. The filler neck 12 is formed to receive a gas pump nozzle 100. The fuel is supplied to the tank inner space 111 of the fuel tank 11 through the filler neck 12 from the gas pump nozzle 100 inserted into the filler neck opening 121. The filler neck opening 121 is normally closed with a tank cap (not shown), which opens and closes the filler neck opening 121.

The tank body 110 has a tank opening 14. The tank opening 14 is formed to communicate the tank inner space 111 with an external part of the tank body 110. The tank opening 14 is formed at a vertically elevated position (upside) relative to the tank body 110, that is, at an upper side of the tank body 110, under a state that the fuel tank 11 is mounted in the vehicle 1. The fuel stored in the fuel tank 11 evaporates and generates evaporated fuel in the tank inner space 111.

The fuel tank system 10 includes a tank passage 21, a purge passage 22, an atmosphere passage 23, a purge valve 41, a canister 30, an electric control valve 70, an electronic control unit (herein referred to as ECU) 50, a fuel level sensor 60 and the like.

The tank passage 21 is provided with its one end being connected to the tank opening 14 of the fuel tank 11. Thus, the tank passage 21 is communicated with the tank inner space 111 of the fuel tank 11 through the tank opening 14. The evaporated fuel generated in the fuel tank 11 flows into the tank passage 21 through the tank opening 14.

The canister 30 includes a case 31, an adsorbent 32 and the like. The case 31 is made of resin and formed in a box shape for example. The casing 31 is provided with case openings 311, 312 and 313. The case openings 311, 312 and 313 are formed to communicate an inside and an outside of the case 31.

The adsorbent 32 is provided inside the case 31. The case opening 311 and the case opening 312 are formed at positions opposite to the case opening 313 relative to the adsorbent 32 in the case 31. The adsorbent 32 is located to be closer to the case opening 313 in an inner space of the case 31. As a result, a space 33 is provided in the case 31 at a part closer to the case openings 311 and 312. The case opening 311 is thus communicated with the case opening 312 through the space 33. As a result, an airflow resistance in the space 33 of the canister 30 between the case opening 311 and the case opening 312 is almost zero, that is, smaller than a predetermined value.

The case opening 311 of the canister 30 is connected to the other end of the tank passage 21. Thus the other end of the tank passage 21 is communicated to the inside of the case 31 through the case opening 311. As a result, the evaporated fuel generated in the fuel tank 11 flows into the inside of the case 31 (space 33) of the canister 30 through the tank opening 14 of the fuel tank 11, the tank passage 21 and the case opening 311.

The adsorbent 32 is activated carbon or the like, for example, which is capable of adsorbing the evaporated fuel. The adsorbent 32 thus adsorbs the evaporated fuel, which generates in the fuel tank 11 and flows into the inside (space 33) of the case 31 through the case opening 311.

One end of the purge passage 22 is connected to the case opening 312 of the canister 30 and the other end of the purge passage 22 is connected to an opening of the intake pipe 3. Thus the one end of the purge passage 22 is communicated with the inside (space 33) of the case 31 of the canister 30 through the case opening 312. The other end of the purge passage 22 is communicated with the intake passage 4 through the opening of the intake pipe 3. With this configuration, the evaporated fuel in the space 33 of the canister 30 is led to the intake passage 4 through the purge passage 22.

One end of the atmosphere passage 23 is connected to the case opening 313 of the canister 30 and the other end of the atmosphere passage 23 is open to the atmosphere. Thus one end of the atmosphere passage 23 is communicated to the inside of the case 31 through the case opening 313.

The evaporated fuel entering into the case 31 through the case opening 311 passes through the adsorbent 32 in flowing to the case opening 313. The evaporated fuel is adsorbed by the adsorbent 32 while flowing toward the case opening 313. As a result, the evaporated fuel contained in air flowing out from the atmosphere passage 23 to the atmosphere side is lower than a predetermined concentration.

The purge valve 41 is provided in the purge passage 22 to open and close the purge passage 22. In the first embodiment, the purge valve 41 is a valve device of a normally-closed type, which remains in a closed valve state when no current is supplied.

The electric control valve 70 is provided in the tank passage 21. In the first embodiment, the electric control valve 70 is located at a position, which is separated from the fuel tank 11 and the canister 30 by predetermined distances. The electric control valve 70 includes a valve member 71 and an electromagnetic driving part 72. The valve member 71 is formed in a rod shape or a plate shape, for example, and provided to be reciprocally movable in an axial direction or in a planar direction. The valve member 71 is capable of variably regulating an open rate of the tank passage 21 in correspondence to a position of its top end part in the tank passage 21. Here, the open rate means a ratio of flow passage area relative to a total cross sectional area of the tank passage 21. The open rate is 0, when the tank passage 21 is closed. The open rate is 1, when the tank passage 21 is fully open. The electromagnetic driving part 72 includes an electromagnetic coil, which generates electromagnetic force to reciprocally move the valve member 71 in response to supply and interruption of current. The electromagnetic driving part 72 is thus capable of regulating the position of the valve member 71 in the tank passage 21 thereby to regulate the open rate of the tank passage 21. In the first embodiment, the electric control valve 70 is a solenoid valve.

When no current is supplied to the electromagnetic driving part 72, the open rate of the tank passage 21 determined by the electric control valve 70 is 0. In the following description, a part of the tank passage 21 located at the fuel tank 11 side relative to the valve member 71 is referred to as a tank-side passage 211 and the other part of the tank passage 21 located at the canister 30 side relative to the valve member 71 is referred to as a canister-side passage 212.

The ECU 50 is a small computer, which includes a CPU as an arithmetic logic unit, ROM, RAM and EEPROM as storage means, and an I/O as input-output circuit and the like. The ECU 50 executes calculations, which are defined by programs stored in the ROM and the like, by using information such as signals received from various sensors provided at various locations in the vehicle 1 and controls operations of various equipment and devices of the vehicle 1. The ECU 50 thus executes the programs stored in a non-transitive storage medium. By the execution of the programs, methods defined by the programs are attained. The ECU 50 includes, as conceptually functional parts, a control part 51, a fill-up detection part 52 and a refill detection part 53. A part or all of the functions, which the ECU 50 executes, may be performed by hardware using one or multiple integrated circuits. That is, the functions provided by the ECU 50 may be attained by software, hardware or combination of software and hardware.

The control part 51 is configured to control the operations of the throttle valve 5, the fuel pump 6, the fuel injection valve and the like based on information such as signals from the sensors. The control part 51 controls the amount of intake air taken into the engine 2, the amount of fuel supplied from the fuel tank 11 to the fuel injection valve and the amount of fuel supplied from the fuel injection valve into the engine 2. The control part 51 further controls the operation of the purge valve 41. For this reason, the control part 51 controls the opening and closing of the purge passage 22.

When the engine 2 is in operation, for example, that is when the air flows through the intake passage 4, the control part 51 controls the operation of the purge valve 41 to open the purge passage 22 upon estimation that the amount of evaporated fuel adsorbed in the canister 30 reached a predetermined value. Thus, vacuum pressure arises in the intake passage 4. As a result, the evaporated fuel adsorbed in the adsorbent 32 and present in the space 33 of the canister 30 are discharged into the intake passage 4 through the purge passage 22. The control part 51 thus controls the operation of the purge valve 41 to purge the evaporated fuel into the intake passage 4.

The control part 51 further controls the operation of the electric control valve 70. The control part 51 controls the open rate of the tank passage 21 by the valve member 71 by controlling current supply to the electromagnetic driving part 72 of the electric control valve 70.

The fuel level sensor 60 includes a detection part 61, an arm 62 and a float 63. The detection part 61 is provided at an elevated position in the vertical direction relative to a tank inner space 111. The arm 62 is provided to extend from the detection part 61 in the vertically downward direction. The arm 62 is rotatable about the detection part 61 as a center of rotation. The float 63 is attached to an end part of the arm 62, which is opposite to the detection part 61. The float 63 generates buoyant force in the fuel. Thus the float 63 moves vertically in the upward direction in the tank body 110 in correspondence to a level of the fuel remaining in the tank body 110. At this time, the arm 62 rotates about the detection part 61 as the center of rotation.

The detection part 61 detects a rotational position of the arm 62. The detection part 61 outputs the signal corresponding to the detected rotational position of the arm 62 to a fill-up detection part 52 of the ECU 50. The fill-up detection part 52 detects the fuel level in the tank body 110 based on the signal received from the detection part 61. Thus the fill-up detection part 52 checks whether the tank body 110 is filled up with fuel. That is, the fill-up detection part 52 detects that the fuel is filled up in the fuel tank 11 based on the signal from the fuel level sensor 60, that is, based on fuel surface position in the fuel tank 11.

The fuel tank system 10 further includes a lid 13, a lid manipulation switch 15, a lid manipulation device 16 and a lid open/close sensor 501. The lid 13 is provided on an outer wall of the vehicle 1 to cover a filler neck opening 121 together with the tank cap. The lid manipulation switch 15 is provided inside the vehicle 1 to be manipulated by a driver of the vehicle 1. The lid manipulation device 16 is configured to open and close the lid 13. When the driver manipulates the lid manipulation switch 15, the lid manipulation device 16 opens the lid 13. After the tank cap is removed, refilling the fuel tank 11 with fuel is enabled.

The lid open/close sensor 501 detects an open/close state of the lid and outputs a signal, which indicates this detected state, to the refill detection part 53 of the ECU 50. Based on the signal received from the lid open/close sensor 501, the refilling detection part 53 detects that refilling of fuel is started when the lid 13 is opened from the closed state. Based on the signal received from the lid open/close sensor 501, the refilling detection part 53 detects that refilling of fuel is finished when the lid 13 is closed from the open state. Thus, the refilling detection part 53 detects refilling the fuel tank 11 with fuel.

When the lid 13 is opened from the closed state, that is, when the refilling detection part 53 detects that the refilling is started, the control part 51 controls the electric control valve 70 to open toward a larger open rate. As a result, the electric control valve 70 is maintained in the open state during a period of refilling the fuel tank 11 with fuel. Thus the fluid in the fuel tank 11 is allowed to flow toward the canister 30 through the tank passage 21. The fuel is thus supplied to the fuel tank 11 smoothly from the gas pump nozzle 100.

When the fill-up detection part 52 detects that the fuel is filled up in the fuel tank 11 while refilling of fuel is being detected by the refill detection part 53, the control part 51 controls the electric control valve 70 to close toward a small open rate. In the first embodiment, the control part 51 decreases the open rate of the tank passage 21 by the electric control valve 70 to 0. Thus the tank passage 21 is closed.

In case that refilling the fuel tank 11 with fuel is continued even after the tank passage 21 is closed by the electric control valve 70, the inner pressure of the fuel tank 11 increases rapidly. In case that the gas pump nozzle 100 includes a pressure sensor therein, the gas pump nozzle 100 automatically stops refilling when the pressure sensor detects a rise of the inner pressure of the fuel tank 11. In case that the gas pump nozzle 100 includes a fuel level sensor therein, the gas pump nozzle 100 automatically stops refilling when the fuel level sensor detects a fuel level in the fuel supply pipe 12.

As described above, the fuel tank system 10 according to the first embodiment includes the tank passage 21, the canister 30, the electric control valve 70, the fill-up detection part 52 and the control part 51. One end of the tank passage 21 is connected to the fuel tank 11, which stores fuel. The canister 30 is connected to the other end of the tank passage 21 and adsorbs the evaporated fuel generated by evaporation of fuel in the fuel tank 11. The electric control valve 70 is operable with current supply to control the amount of fluid flowing through the tank passage 21 by varying the open rate of the tank passage 21. The fill-up detection part 52 detects that the fuel tank 11 is filled up with fuel based on the fuel level in the fuel tank 11 without detecting the inner pressure of the fuel tank 11. The control part 51 controls the operation of the electric control valve 70.

According to the first embodiment, the control part 51 controls the electric control valve 70 in the valve closing direction, which decreases the open rate of the tank passage 21, when the fill-up detection part 52 detects that the fuel tank 11 is filled up with fuel. As a result, the amount of fluid flowing through the tank passage 21 decreases. The fluid flowing through the tank passage 21 is not the liquid fuel but the evaporated fuel.

Thus, even when the fuel is supplied further into the fuel tank 11 after the fuel tank 11 is filled up with fuel, the fuel and the evaporated fuel are restricted from flowing to the canister 30 side through the tank passage 21. According to the first embodiment, the fill-up detection part 52 detects that the fuel tank 11 is filled up with fuel without detecting the pressure present in the fuel tank 11. As a result, it is possible to appropriately control the amount of fluid flowing through the tank passage 21 at the time of fill-up of fuel in the fuel tank 11 in a simple configuration without using the conventionally-used float valve and pressure sensor.

Further, according to the first embodiment, when the fill-up detection part 52 detects that the fuel is filled up, the control part 51 controls the electric control valve 70 in the valve closing direction toward the open rate of the tank passage 21 to 0. Thus, when the fuel is filled up, the tank passage 21 is surely closed. As a result, even when the fuel is supplied further into the fuel tank 11 after the fuel tank 11 is filled up with fuel, the fuel and the evaporated fuel are restricted from flowing to the canister 30 side through the tank passage 21.

Still further, according to the first embodiment, the electric control valve 70 includes the valve member 71, which varies the open rate of the tank passage 21, and the electromagnetic driving part 72, which drives the valve member 71 to vary the open rate of the tank passage 21. As a result, the electric control valve 70 is configured comparatively simply. Further, the electric control valve 70 is controlled comparatively simply.

### Second Embodiment

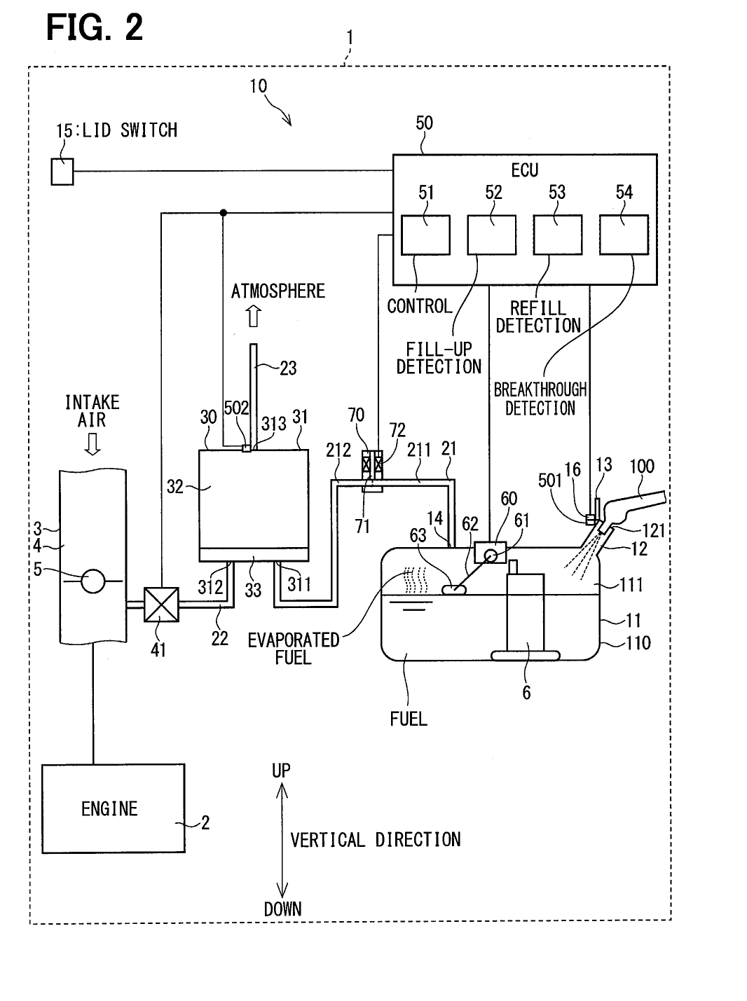

A fuel tank system according to a second embodiment is shown in FIG. 2. In the second embodiment, a concentration sensor 502 is provided additionally. Further, the ECU 50 includes a breakthrough prediction part 54 additionally.

The concentration sensor 502 is provided to the canister 30. The concentration sensor 502 detects a concentration of the evaporated fuel in the canister 30 and outputs a signal indicating a detected concentration to the breakthrough detection part 54 of the ECU 50. The breakthrough detection part 54 detects a breakthrough of the canister 30 or predicts a breakthrough time of the canister 30 based on the signal received from the concentration sensor 502. The breakthrough of the canister 30 means that the evaporated fuel adsorbed by the canister 30 reached a maximum value of evaporated fuel adsorption of the canister 30.

When the breakthrough detection part 54 detects the breakthrough of the canister 30 or predicts the breakthrough which will occur after a certain time lapse, the control part 51 controls the electric control valve 70 in the valve closing direction. Thus, the evaporated fuel is restricted from flowing into the canister 30 through the tank passage 21 and being discharge in the atmosphere through the canister 30, which is in the breakthrough state.

In the second embodiment, even in the course of refilling of the fuel tank 11, the control part 51 controls the electric control valve 70 to operate in the valve closing direction upon detection of the breakthrough or prediction of the coming breakthrough of the canister 30. Thus the flow amount of the fluid flowing through the tank passage 21 decreases. In the second embodiment, the open rate of the tank passage 21 is decreased to 0 so that the tank passage 21 is closed.

When the fuel is refilled into the fuel tank 11 continuously even after the closure of the tank passage 21, the inner pressure of the fuel tank 11 rises rapidly. In case of the gas pump nozzle 100 having the pressure sensor, refilling of the fuel from the gas pump nozzle 100 is stopped automatically when the pressure sensor detects a rise of the inner pressure of the fuel tank 11. The second embodiment has the additional configuration and operation described above in addition to the configuration and operation of the first embodiment.

As described above, according to the second embodiment, the breakthrough detection part 54 is provided additionally. The breakthrough detection part 54 detects the breakthrough of the canister 30 or predicts the possible breakthrough time of the canister 30. The control part 51 controls the electric control valve 70 to operate in the valve closing direction upon detection of the breakthrough or prediction of the coming breakthrough of the canister 30. Thus the flow amount of the fluid flowing through the tank passage 21 decreases. When the fuel is refilled into the fuel tank 11 continuously even after the closure of the tank passage 21, the inner pressure of the fuel tank 11 rises rapidly. In case of the gas pump nozzle 100 having the pressure sensor, refilling of the fuel from the gas pump nozzle 100 is stopped automatically when the pressure sensor detects the rise of the inner pressure of the fuel tank 11. Thus it is possible to stop refilling the fuel tank 11 before the evaporated fuel is discharged into the atmosphere through the canister 30.

### Third Embodiment

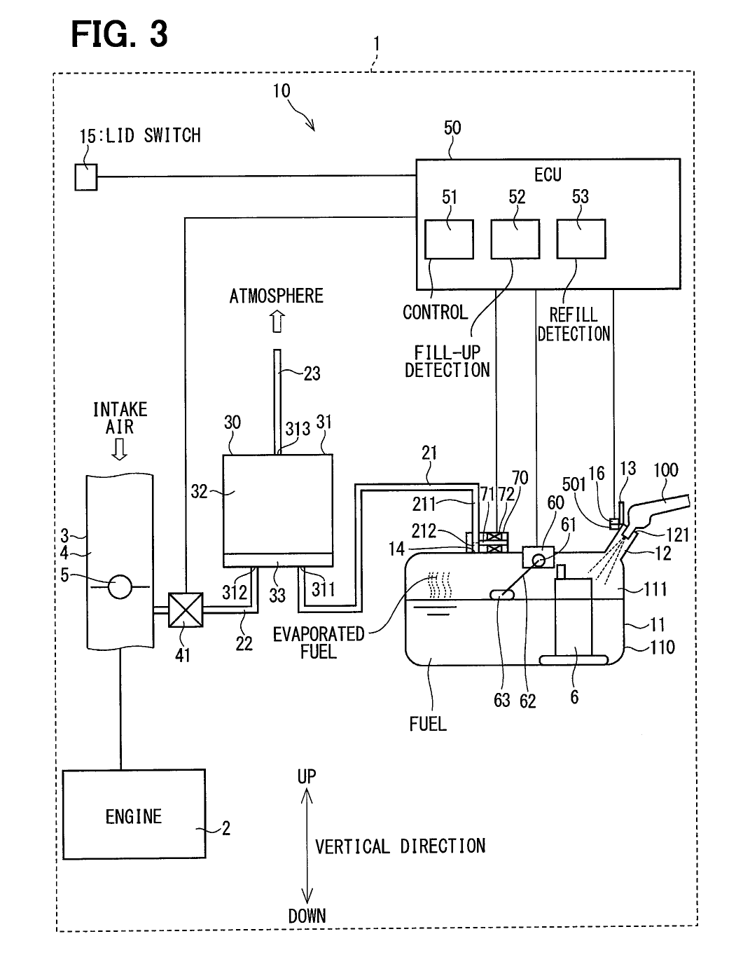

A fuel tank system according to a third embodiment is shown in FIG. 3. In the third embodiment, the electric control valve 70 is located at a position different from that in the first embodiment. In the third embodiment, the electric control valve 70 is provided at the end part of the tank passage 21, which is at the fuel tank 11 side. The electric control valve 70 is attached in contact with an outer wall of the tank body 110 of the fuel tank 11. In comparison to the first embodiment, a volume of the tank-side passage 211 of the tank passage 21 is small. The third embodiment has the additional configuration and operation described above in addition to the configuration and operation of the first embodiment.

In the third embodiment, the electric control valve 70 is provided at the end part of the tank passage 21, which is at the fuel tank 11 side. As a result, the volume of the tank-side passage 211 of the tank passage 21 is decreased. When the fuel is refilled into the fuel tank 11 continuously even after the closure of the tank passage 21, the inner pressure of the fuel tank 11 rises rapidly. In case of the gas pump nozzle 100 having the pressure sensor, refilling of the fuel from the gas pump nozzle 100 is stopped automatically when the pressure sensor detects the rise of the inner pressure of the fuel tank 11.

### Fourth Embodiment

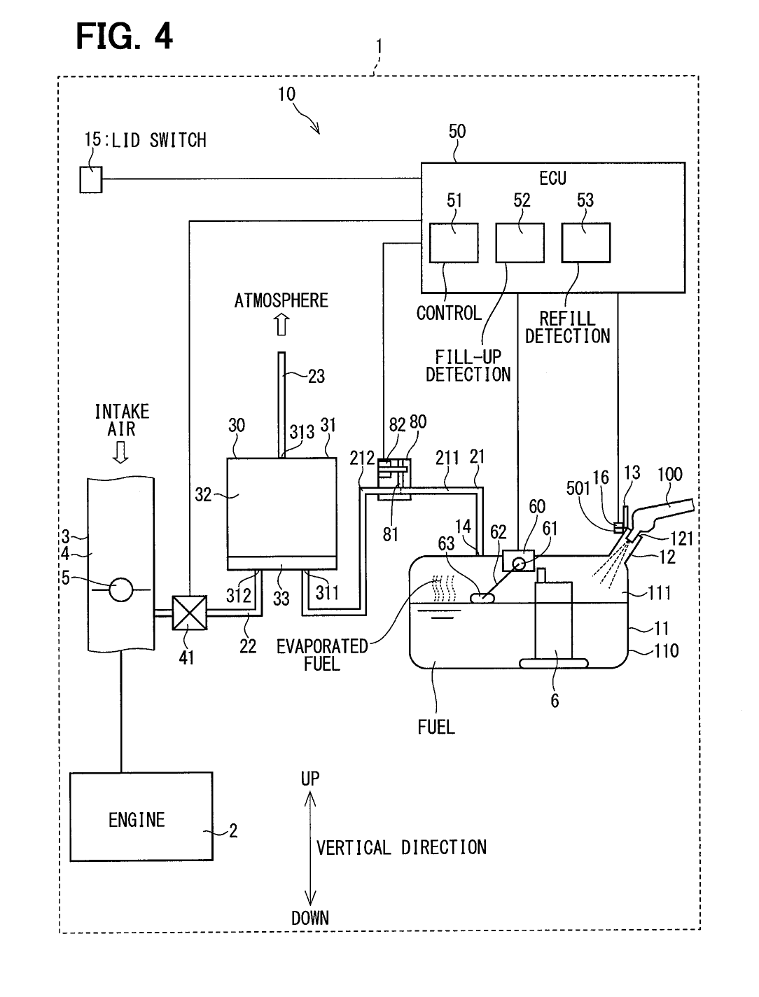

A fuel tank system according to a fourth embodiment is shown in FIG. 4. In the fourth embodiment, an electric control valve 80 is provided in the tank passage 21 in place of the electric control valve 80. The electric control valve 80 is configured and controlled differently from the electric control valve 70 in the first embodiment. In the fourth embodiment, the electric control valve 80 is located at a position separated from the fuel tank 11 and the canister 30 by predetermined distances. The electric control valve 80 includes a valve member 81 and a motor 82.

The valve member 81 is formed in a rod shape or a plate shape and reciprocally movable in the axial direction or planar direction. The valve member 81 regulates the open rate of the tank passage 21 in accordance with a position of its top end part in the tank passage 21. The motor 82 is driven with current supply to regulate the position of the valve member 81. Thus the motor 82 regulates the open rate of the tank passage 21 by way of the valve member 81.

The control part 51 controls the open rate of the tank passage 21 by the valve member 81 by controlling the current supplied to the motor 82. The control part 51 stops the valve member 81 at an arbitrary position by interrupting the current supply to the motor 82.

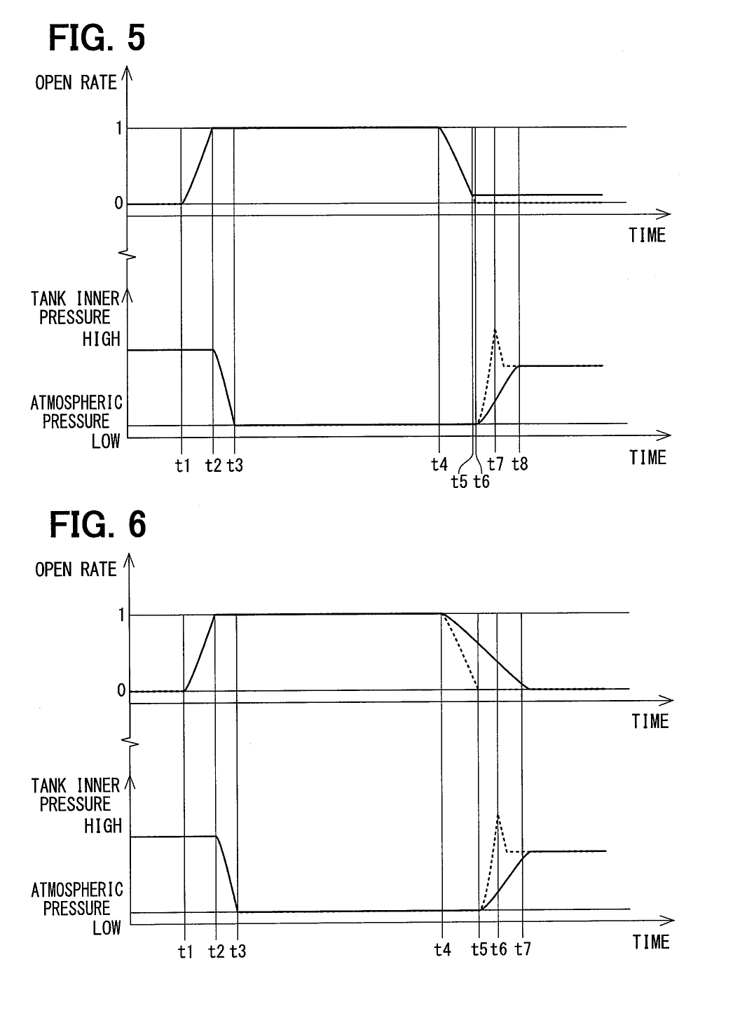

An exemplary operation of the fuel tank system 10 according to the fourth embodiment will be described next. As indicated by a solid line in FIG. 5, when the refill detection part 53 detects the start of refilling of fuel at time t1, the control part 51 controls the electric control valve 80 to operate in the opening direction to increase the open rate of the tank passage 21. The open rate of the tank passage 21 thus reaches 1 at time t2. As a result, the inner pressure of the fuel tank 11, that is, tank inner pressure, decreases. The tank inner pressure thus decreases to about the atmospheric pressure at time t3.

When the fill-up detection part 52 detects that the fuel is filled up at time t4 as a result of continuation of refilling of fuel during a period between time t3 and time t4 after the start of refilling at time t1, for example, the control part 51 controls the electric control valve 80 to operate in the valve closing direction to decrease the open rate of the tank passage 21. In the fourth embodiment, when the fill-up detection part 52 detects that the fuel is filled up to a maximum level at time t4, the control part 51 controls the electric control valve 80 in the valve closing direction thereby to regulate the open rate of the tank passage 21 to a predetermined open rate. The predetermined open rate is larger than 0 and smaller than a maximum open rate of the tank passage 21, that is, it is about an open rate, which allows a predetermined amount of the fluid flowing through the tank passage 21 under the refilling state to flow and the tank inner pressure to rise. In the fourth embodiment, for example, the predetermined open rate corresponds to a flow amount of fluid of about 5 liters per minute (l/m) or less, which flows in the tank passage 21 under the refilling state. The flow amount of the fluid, which flows in the tank passage 21 in the maximum open rate under refilling of fuel by the gas pump nozzle 100, is generally about 40 liters per minute (l/m). The fluid, which flows in the tank passage 21, is not the liquid fuel but the evaporated fuel.

When the open rate of the tank passage 21 is decreased to the predetermined open rate, the tank inner pressure gradually increases thereafter and remains at a constant level after reaching the constant level at time t8. When the pressure sensor provided in the gas pump nozzle 100 detects the rise of the inner pressure of the fuel tank 11 between time t5 and time t8, the gas pump nozzle 100 automatically stops refilling of fuel.

An advantageous effect of the fourth embodiment will be described below in comparison to an exemplary operation of a fuel tank system according to a comparison example, which is indicated by a dotted line in FIG. 5. The fuel tank system according to the comparison example is configured similarly to that of the fourth embodiment. However, the control part 51 controls the electric control valve 80 differently from that of the fourth embodiment. In the fuel tank system according to the comparison example, when the fill-up detection part 52 detects the fill-up of the fuel at time t4, the control part 51 controls the electric control valve 80 to operate in the valve closing direction and decreases the open rate of the tank passage 21 to 0 at time t6. The tank inner pressure thus rapidly rises after time t6 and overshoots at time t7. As a result, the fuel is likely to spill over the refill opening 121 of the filler neck 12.

In the fourth embodiment described above, when the fill-up detection part 52 detects the fill-up of fuel at time t4, the control part 51 controls the electric control valve 80 to operate in the valve closing direction to the predetermined open rate at time t5. As a result, the tank inner pressure rises slowly thereafter. It is thus possible to suppress overshooting of the tank inner pressure, which arises in the comparison example, and prevent the fuel from spilling over the fuel refill opening 121 of the filler neck 12.

As described above, according to the fourth embodiment, when the fill-up detection part 52 detects the fill-up of fuel in the fuel tank, the control part 51 controls the electric control valve 80 to operate in the valve closing direction so that the open rate of the tank passage 21 is regulated to the predetermined open rate, which is larger than 0 but smaller than the maximum open rate. By setting the predetermined open rate to a rate, which allows the predetermined amount of fluid to flow through the tank passage 21 under the fuel refilling state and the tank inner pressure to rise, the tank inner pressure is increased while preventing the overflow of fuel from the fuel refill opening 121. In case that the gas pump nozzle 100 is provided with the pressure sensor, the gas pump nozzle 100 automatically stops refilling of fuel upon detection of the rise of the inner pressure of the fuel tank 11.

In addition, according to the fourth embodiment, the electric control valve 80 includes the valve member 81, which varies the open rate in the tank passage 21, and the motor 82, which drives the valve member 81 to vary the open rate with the current supply. The control part 51 thus stops the valve member 81 at the arbitrary position by interrupting the current supply to the motor 82. As a result, it is possible to precisely control the open rate of the tank passage 21 to the predetermined open rate by the electric control valve 80. For stopping the electric control valve 80 at the predetermined open rate of the tank passage 21, the current supply to the electric control valve 80 is interrupted. As a result, power consumption of the electric control valve 80 is decreased.

### Fifth Embodiment

A fuel tank system according to a fifth embodiment will be described with reference to FIG. 6. In the fifth embodiment, the electric control valve is controlled differently from that of the fourth embodiment. The fuel tank system is configured similarly to that of the fourth embodiment. In the fifth embodiment, however, the control part 51 controls current supply to the motor 82 to control a moving speed of the valve member 81.

An exemplary operation of the fuel tank system 10 according to the fifth embodiment will be described below. As indicated by a solid line in FIG. 6, when the refill detection part 53 detects the start of refilling of fuel at time t1, the control part 51 controls the electric control valve 80 to operate in the opening direction to increase the open rate of the tank passage 21. The open rate of the tank passage 21 thus reaches 1 at time t2. As a result, the inner pressure of the fuel tank 11, that is, tank inner pressure, decreases. The tank inner pressure thus decreases to about the atmospheric pressure at time t3.

When the fill-up detection part 52 detects that the fuel is filled up at time t4 as a result of continuation of refilling of fuel during the period between time t3 and time t4 after the start of fuel refilling at time t1, for example, the control part 51 controls the electric control valve 80 to operate in the valve closing direction to decrease the open rate of the tank passage 21. In the firth embodiment, the control part 51 controls the electric control valve 80 in the valve closing direction thereby to decrease the open rate of the tank passage 21 gradually. As a result of gradual decrease in the open rate of the tank passage 21 from time t4 to time t7, the open rate of the tank passage 21 is decreased finally to 0. In the fifth embodiment, the period from time t4 to time t7 is about 50 milliseconds (ms). That is, the control part 51 varies the open rate of the tank passage 21 from 1 to 0 during the period of about 50 ms. As a result of control of the control part 51 for the electric control valve 80, the tank inner pressure gradually rises from time t5 to time t7 and remains to be the same after time t7. When the pressure sensor provided in the gas pump nozzle 100 detects the rise of the inner pressure of the fuel tank 11 between time t5 and time t7, refilling of fuel by the gas pump nozzle 100 is stopped automatically.

An advantageous effect of the fifth embodiment will be described below in comparison to an exemplary operation of a fuel tank system according to a comparison example, which is indicated by a dotted line in FIG. 6. The fuel tank system according to the comparison example is configured similarly to that of the fifth embodiment. However, the control part 51 controls the electric control valve 80 differently from that of the fifth embodiment. In the fuel tank system according to the comparison example, when the fill-up detection part 52 detects the fill-up of the fuel at time t4, the control part 51 controls the electric control valve 80 to operate in the valve closing direction and decreases the open rate of the tank passage 21 to 0 at time t5. The predetermined period is about 30 ms to 40 ms, for example. The tank inner pressure thus rapidly rises after time t5 and overshoots at time t6. As a result, the fuel is likely to spill over the refill opening 121 of the filler neck 12.

In the fifth embodiment described above, when the fill-up detection part 52 detects the fill-up of fuel at time t4, the control part 51 controls the electric control valve 80 to operate in the valve closing direction to the predetermined open rate at time t5. As a result, the tank inner pressure rises slowly after time t5. It is thus possible to suppress overshooting of the tank inner pressure, which arises in the comparison example, and prevent the fuel from spilling over the fuel refill opening 121 of the filler neck 12.

As described above, according to the fifth embodiment, when the fill-up detection part 52 detects the fill-up of fuel in the fuel tank, the control part 51 controls the electric control valve 80 to operate in the valve closing direction so that the open rate of the tank passage 21 is regulated to gradually decrease. When the refilling of fuel is continued even after the fill-up of fuel in the fuel tank under the fuel refilling state, the tank inner pressure increases gradually. As a result, the tank inner pressure is increased while preventing the overflow of fuel from the fuel refill opening 121. In case that the gas pump nozzle 100 is provided with the pressure sensor, the gas pump nozzle 100 automatically stops refilling of fuel upon detection of the rise of the inner pressure of the fuel tank 11 by the pressure sensor.

### Sixth Embodiment

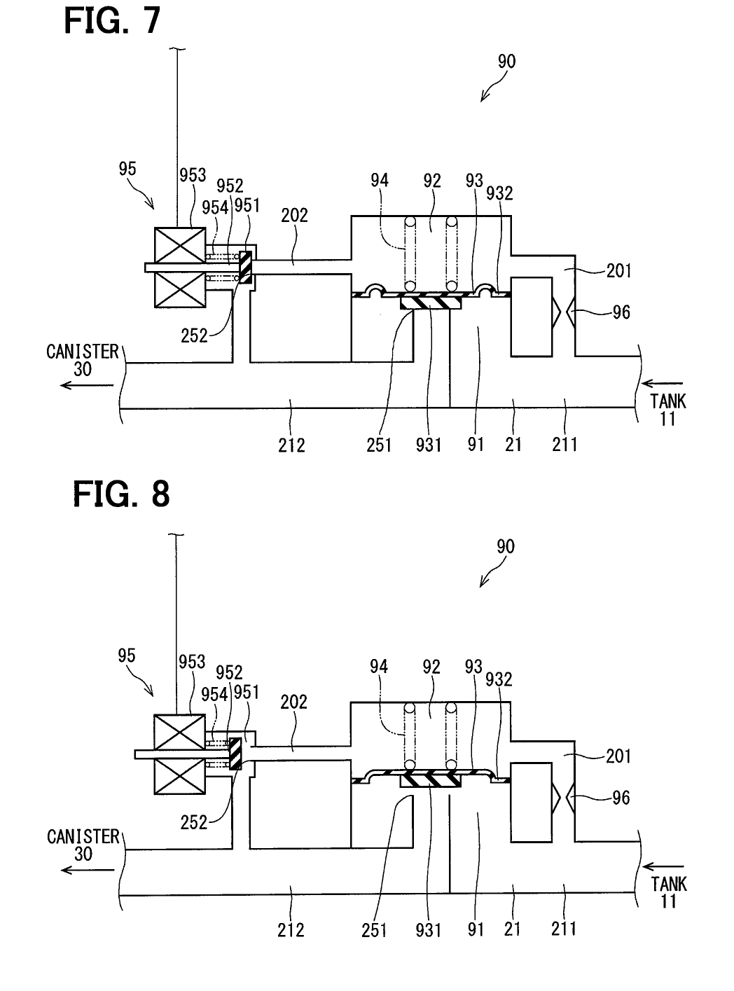

A fuel tank system according to a sixth embodiment is shown only partly in FIG. 7 and FIG. 8. In the sixth embodiment, the fuel tank system includes an electric control valve 90, which is configured differently from that of the first embodiment. The electric control valve 90 is provided in the tank passage 21. In the sixth embodiment, the electric control valve 90 is located at a position separated from the fuel tank 11 and the canister 30 by predetermined distances. The electric control valve 90 includes a main chamber 91, a back-pressure chamber 92, a pressure valve 93, a spring 94, an electromagnetic valve 95, a throttle part 96 and the like.

The main chamber 91 is formed at an end part, which is at the canister-side passage 212 of the tank-side passage 211. The main chamber 91 is formed annularly around a circumference of the end part, which is at the tank-side passage 211 side of the canister-side passage 212. A valve seat 251 is formed at an end part, which is at the tank-side passage 211 of the canister-side passage 212. The back-pressure chamber 92 is provided adjacently to the main chamber 91. The back-pressure chamber 92 and the tank-side passage 211 are connected by a first bypass passage 201. The back-pressure chamber 92 and the canister-side passage 212 are connected by a second bypass passage 202. A valve seat 252 is formed in a middle of the second bypass passage 202.

The pressure valve 93 is provided between the main chamber 91 and the back-pressure chamber 92. The pressure valve 93 is formed of a valve member 931 and a diaphragm 932. The valve member 931 is made of an elastic material such as rubber and formed in a plate shape. The diaphragm 932 is made of an elastic material such as rubber and formed in a thin plate shape. The diaphragm 932 is provided to partition the main chamber 91 and the back-pressure chamber 92. The valve member 931 is provided on a surface of the diaphragm 932, which is on the main chamber 91 side. A surface of the valve member 931, which is on an opposite side to the diaphragm 932, is movable to contact the valve seat 251 and leave from the valve seat 251.

The spring 94 is provided in the back-pressure chamber 92. The spring 94 is a coil spring and biases the pressure valve 93 such that the valve member 931 is pressed to the valve seat 251. When a pressure in the main chamber 91 is higher than that of the back-pressure chamber 92, the diaphragm 932 deforms in a direction to leave from the valve seat 251 against the biasing force of the spring 94. The valve member 931 thus leaves from the valve seat 252.

When the valve member 931 is in contact with the valve seat 251, the open rate of the tank passage 21 (pressure valve 93) in the tank passage 21 is 0. At this time, the tank-side passage 211 and the canister-side passage of the tank passage 21 are closed. As the valve member 931 leaves from the valve seat 251, the open rate of the tank passage 21 (pressure valve 93) in the tank passage 21 increases.

The electromagnetic valve 95 is formed of a valve member 951, a shaft part 952, an electromagnetic driving part 953 and a spring 954. The valve member 951 is made of an elastic material such as rubber and formed in a plate shape. The valve member 951 has a surface, which is movable to contact the valve seat 252 and leave from the valve seat 252. The shaft part 952 is formed in a rod shape, which extends from the valve member 951 toward a side opposite to the valve seat 252. The shaft part 952 is reciprocally movable in an axial direction together with the valve member 951. The electromagnetic driving part 953 has a coil, for example, to generate magnetic force in response to current supply and reciprocally move the valve member 951 and the shaft part 952 in the axial direction. The electromagnetic driving part 953 varies the open rate of the second bypass passage 202 by the valve member 951. In the sixth embodiment, the electromagnetic valve 95 is a solenoid valve. The spring 954 is a coil spring, which biases the valve member 951 and the shaft part 952 such that the valve member 951 is pressed to the valve seat 252.

In response to the current supply to the electromagnetic driving part 953, the valve member 951 and the shaft part 952 move toward a position opposite to the valve seat 252 against the biasing force of the spring 954. Thus the valve member 951 leaves from the valve seat 252. Thus the electromagnetic valve 95 operates with the current supply to open and close the second bypass passage 202, that is, the passage part between the back-pressure chamber 92 and the canister 30. When no current is supplied to the electromagnetic valve 95, the valve member 951 contacts the valve seat 252 and shuts down the passage between the back-pressure chamber 92 and the canister 30. The biasing force of the spring 954 is set to be comparatively small. For this reason, even in case that the electric current supplied to the electromagnetic valve 95 is comparatively small, the valve member 951 is enabled to leave from the valve seat 252 to open the second bypass passage 202.

The throttle part 96 is provided in the first bypass passage 201. The throttle part 96 is formed circularly so that its inner diameter is smaller than that of the first bypass passage 201. That is, the throttle part 96 restricts the fluid from flowing in the first bypass passage 201. For this reason, when a pressure difference arises between the tank-side passage 211 side and the back-pressure chamber 92 side in the first bypass passage 201, the fluid flows through the throttle part 96 slowly. Thus the pressure difference between the tank-side passage 211 side and the back-pressure chamber 92 side in the first bypass passage 201 is decreased slowly as time lapses.

The control part 51 controls the open rate of the pressure valve 93 by controlling the current supply to the electromagnetic valve 95. For example, when the fuel evaporates in the fuel tank 11 under a state that the electromagnetic valve 95 closes the back-pressure chamber 92 and the canister 30, pressures in the tank-side passage 211 of the tank passage 21, the main chamber 91, the first bypass passage 201 and the back-pressure chamber 92 become higher than the atmospheric pressure. When the control part 51 controls the current supply to the electromagnetic valve 95 so that the valve member 951 leaves from the valve seat 252 as shown in FIG. 8, the pressure in the back-pressure chamber 92 becomes generally equal to the atmospheric pressure similarly to the pressure in the canister-side passage 212 of the tank passage 21. Thus the pressure in the back-pressure chamber 92 becomes negative relative to that of the main chamber 91. The diaphragm 932 deforms such that the valve member 931 leaves from the valve seat 251. As a result, the fluid in the tank-side passage 211 flows to the atmosphere side through the valve seat 251, the canister-side passage 212, the canister 30 and the atmospheric passage 23. The tank inner pressure correspondingly falls. Since the throttle part 96 restricts the fluid flow in the first bypass passage 201, the valve member 931 continues to be separated away from the valve seat 251 for a predetermined period.

In the sixth embodiment, when the lid 13 is changed from the closed state to the open state, that is, when the refill detection part 53 detects the start of refilling of fuel into the fuel tank 11, the control part 51 controls the electromagnetic valve 95 to open the second bypass passage 202 and controls the electric control valve 90 to operate in the valve opening direction to increase the open rate. The pressure valve 93 of the electric control valve 90 thus remains to be open as shown in FIG. 8 during the refilling of fuel into the fuel tank 11. As a result, the fluid in the fuel tank 11 is allowed to flow to the canister 30 side through the tank passage 21. It is thus possible to supply the fuel smoothly from the gas pump nozzle 100 into the fuel tank 11.

When the fill-up detection part 52 detects that the fuel is filled up in the fuel tank 11 during a period that the refilling detection part 53 continues detection of the refilling of fuel by the refilling detection part 53, the control part 51 controls the electromagnetic valve 95 to close the second bypass passage 202 and controls the electric control valve 90 to operate in the valve closing direction to decrease the open rate of the tank passage 21. As a result, the valve member 931 of the pressure valve 93 contacts the valve seat 251 and so that communication between the tank-side passage 211 and the canister-side passage 212 of the tank passage 21 is interrupted as shown in FIG. 7.

According to the sixth embodiment described above, the electric control valve 90 includes the main chamber 91, which is formed in the tank passage 91 and communicated with the fuel tank 11, the back-pressure chamber 92, which is formed in the tank passage 21 and communicated with the fuel tank 11 and the canister 30, the pressure valve 93, which varies the open rate of the tank passage 21 with the pressure difference between the main chamber 91 and the back-pressure chamber 92, and the electromagnetic valve 95, which operates with current supply to open and close the passage between the back-pressure chamber 92 and the canister 30. As a result, when the back-pressure chamber 92 and the canister 30 are communicated through the electromagnetic valve 95 under the state that the pressures in the main chamber 91 and the back-pressure chamber 92 are higher than the atmospheric pressure, the pressure in the back-pressure chamber 92 side becomes lower relative to that in the main chamber 91 so that the pressure valve 93 is opened. The electromagnetic valve 95 can separate the valve member 951 from the valve seat 252 with small electric current supply. Thus power consumption of the electric control valve 90 is decreased and hence the electromagnetic valve 95 and the electric control valve 90 are configured to be small.

### Other Embodiment

In the first embodiment, the control part 51 is exemplified to control the electric control valve 70 in the valve closing direction to decrease the open rate of the tank passage 21 to 0, when the fill-up detection part 52 detects the fill-up of fuel under the state that the refill detection part 53 detects the refilling. As the other embodiment of the fuel tank system 10, the control part 51 may be configured to control a duty ratio of electric power supplied to the electromagnetic driving part 72 of the electric control valve 70 to regulate the open rate of the tank passage 21 to the predetermined open rate, when the fill-up detection part 52 detects the fill-up of fuel. This embodiment also provides the same advantages as the fourth embodiment. Similarly, in the sixth embodiment, the control part 51 may be configured to control a duty ratio of electric power supplied to the electromagnetic driving part 953 of the electric control valve 90 to regulate the open rate of the pressure valve 93 of the electric control valve 90 to the predetermined open rate, when the fill-up detection part 52 detects the fill-up of fuel.

Further, as the other embodiment of the fuel supply system 10, the control part 51 may be configured to control a duty ratio of electric power supplied to the electromagnetic driving part 72 of the electric control valve 70 to gradually decrease the valve closing direction in case of operating the electric control valve 70 in the valve closing direction, when the fill-up detection part 52 detects the fill-up of fuel. This embodiment also provides the similar advantage as the fifth embodiment. Similarly, in the sixth embodiment, the control part 51 may be configured to control a duty ratio of electric power supplied to the electromagnetic driving part 953 of the electric control valve 90 to control the electric control valve 90 to gradually decrease the open rate of the pressure valve 93, when the fill-up detection part 52 detects the fill-up of fuel in the fuel tank 11.

In the second embodiment, the breakthrough detection part 54 is exemplified to detect the breakthrough of the canister 30 or predict the breakthrough time of the canister 30 based on the signal outputted from the concentration sensor 502, which detects the concentration of evaporated fuel in the canister 30. As the other embodiment of the fuel tank system 10, the breakthrough detection part 54 may detect the breakthrough of the canister 30 or predict the breakthrough time of the canister based on the signal outputted from the pressure sensor, which detects the pressure in the canister 30. Further, in the embodiments described above, the fill-up detection part 52 is exemplified to detect the fill-up of fuel in the fuel tank 11 based on the signal outputted from the fluid level sensor 60 provided in the fuel tank 11. As the other embodiment of the fuel tank system 10, the fill-up of fuel in the fuel tank 11 may be detected based on the signal outputted from the liquid level sensor 60 (sender gauge) provided in the fuel pump 6.

As the other embodiment of the fuel tank system 10, the fill-up detection part 52 is not limited to the liquid level sensor 60, which has the arm 62 and the float 63, as far as it is possible to detect the liquid level of fuel in the fuel tank 11. For example, the fill-up of fuel in the fuel tank 11 may be detected based on a signal from an optical sensor, an electric resistance sensor, a float position sensor or the like. The optical sensor detects a fuel level by emitting light onto a fuel surface and detecting a reflectance or refraction index. The electric resistance sensor detects a fuel level by detecting an electric resistance of a resistor. The float position sensor detects a fuel level by detecting a position of a float, which generates a buoyant force of the float in the fuel. As exemplified above, the fuel tank system 10 is not limited to the embodiments described above and may be implemented in a variety of embodiments.

What is claimed is:

1. A fuel tank system comprising:
a tank passage having one end connected to a fuel tank, which stores fuel;
a canister connected to an other end of the tank passage for adsorbing evaporated fuel generated by evaporation of the fuel in the fuel tank;
an electric control valve operable with current supply for controlling an amount of fluid flowing through the tank passage by varying an open rate of the tank passage;
a fill-up detection part for detecting that the fuel tank is filled up with fuel based on a fuel level in the fuel tank without detecting an inner pressure of the fuel tank; and
a control part for controlling an operation of the electric control valve,
wherein the control part controls the electric control valve in a valve closing direction to decrease the open rate of the tank passage, when the fill-up detection part detects that the fuel tank is filled up with fuel.

2. The fuel tank system according to claim 1, wherein:
the control part controls the electric control valve to operate in the valve closing direction to an open rate 0, when the fill-up detection part detects that the fuel tank is filled up with fuel.

3. The fuel tank system according to claim 1, wherein:
the control part controls the electric control valve to operate in the valve closing direction to a predetermined open rate, which is larger than 0 but smaller than a maximum open rate, when the fill-up detection part detects that the fuel tank is filled up with fuel.

4. The fuel tank system according to claim 1, further comprising:
a breakthrough detection part for detecting a breakthrough of the canister or predicting a possible breakthrough time of the canister,
wherein the control part controls the electric control valve to operate in the valve closing direction upon detection of the breakthrough or prediction of a coming breakthrough of the canister.

5. The fuel tank system according to claim 1, wherein:
the control part controls the electric control valve to operate in the valve closing direction so that the open rate of the tank passage is regulated to gradually decrease, when the fill-up detection part detects that the fuel tank is filled up with fuel.

6. The fuel tank system according to claim 1, wherein the electric control valve includes:
a valve member for varying the open rate of the tank passage; and
an electromagnetic driving part for driving the valve member to vary the open rate of the tank passage.

7. The fuel tank system according to claim 1, wherein the electric control valve includes:
a valve member for varying the open rate of the tank passage; and
a motor for driving the valve member with current supply.

8. The fuel tank system according to claim 1, wherein the electric control valve includes:
a main chamber formed in the tank passage and communicated with the fuel tank;
a back-pressure chamber formed in the tank passage and communicated with the fuel tank and the canister;
a pressure valve for varying the open rate of the tank passage with a pressure difference between the main chamber and the back-pressure chamber; and
an electromagnetic valve operable with current supply to open and close a passage between the back-pressure chamber and the canister.
